(19) United States
(12) Patent Application Publication
(10) Pub. No.: US 2018/0190436 A1
(43) Pub. Date: Jul. 5, 2018

(54) TUNABLE ELECTRONIC NANOCOMPOSITES WITH PHASE CHANGE MATERIALS AND CONTROLLED DISORDER

(71) Applicants: The Charles Stark Draper Laboratory, Inc., Cambridge, MA (US); President and Fellows of Harvard College, Cambridge, MA (US)

(72) Inventors: Amy Elizabeth Duwel, Cambridge, MA (US); Douglas W. White, Lexington, MA (US); Shriram Ramanathan, West Lafayette, IN (US); Jacob P. Treadway, Lexington, MA (US)

(21) Appl. No.: 15/858,712

(22) Filed: Dec. 29, 2017

Related U.S. Application Data
(60) Provisional application No. 62/439,917, filed on Dec. 29, 2016.

(51) Int. Cl. H01G 7/00; H01G 7/04; H01G 7/06; H01P 3/00; C09K 5/06

(52) U.S. Cl. CPC H01G 7/00; H01G 7/04; C09K 5/06; H01P 3/003; H01G 7/06

(57) ABSTRACT

Phase change materials such as correlated oxides (e.g., such as NbO₂, V₂O₃ and VO₂) enable wide tuning of dielectric properties via control of temperature, electric fields, optical fields or disorder. The distinct dielectric states can be volatile or non-volatile depending on how the phase is created. Possible fabrication techniques for oxide and insulating matrix composites may include sequential/co-deposition routes as well as local controlled disorder. By combining the distinct insulating and metallic states in these systems and by control of the ground state via induced defects, artificial electronic composites, whose properties can be tuned, could be manufactured. The composites can be integral components of coplanar waveguide devices and microwave switches. More broadly, tunable electronic composites using oxide systems that undergo insulator-metal transitions may have wide usage in frequency tunable devices, including microwave devices.

### RELATED APPLICATIONS

This application claims the benefit under 35 USC 119(e) of U.S. Provisional Application No. 62/439,917, filed on Dec. 29, 2016, which is incorporated herein by reference in its entirety.

### BACKGROUND OF THE INVENTION

During the past decade, the search for low loss, high permittivity dielectrics has been motivated by commercial and defense demands for smaller, lower power systems. One approach that has delivered useful results has been to engineer a composite material made from a low loss dielectric matrix loaded with metal inclusions. The metal particles are often randomly distributed but must be below a “percolation” threshold. (Percolation density is defined as that concentration of metal particles at which they nearly touch and can form continuous paths for current flow). This composite material is sometimes called a “metamaterial”, although it is different from those composite media where the metal inclusions consist of a periodic array of resonators (also called a metamaterial in the literature). In both cases, however, the composite “metamaterial” appears homogeneous at length scales comparable to the operating wavelength, and effective permittivity expressions are considered applicable.

For the engineered material in which randomly distributed metal particles are embedded in low loss dielectric, the effective permittivity can be increased by 1-2 orders of magnitude over the uniform dielectric permittivity according to published literature (see Merrill, et al., “Effective medium theories for artificial materials composed of multiple sizes of spherical inclusions in a host continuum,” IEEE Transactions on Antennas and Propagation, vol 47, no 1, January 1999; and Sarychev et al., “Electrodynamics of metal-dielectric composites and electromagnetic crystals,” Physical Review B, vol 62, no 12, September 2000). In addition, the effective dielectric loss remains low, which is desirable for radio frequency (RF) applications.

In parallel, ultra-fast electrical switching dynamics in VO₂ coplanar waveguide devices has been demonstrated (Ha, Zhou, Fisher, Ramanathan, and Treadway, “Electrical switching dynamics and broadband microwave characteristics of VO₂ radio frequency devices,” Journal of Applied Physics, vol. 113, pp. 184501, 2013). In addition; RF-triggering of the insulator-metal transition has also been demonstrated (Ha, Zhou, Fisher, Ramanathan, and Treadway, IEEE Microwave Wireless Comp Lett, vol. 24, pp. 575-577, 2014).

### SUMMARY OF THE INVENTION

The present invention concerns engineered materials using phase change inclusions in a dielectric substrate or matrix to enable tunability. The voltage-switched transition between metallic and insulating states results in a widely tunable effective permittivity.

Phase change materials, such as correlated oxides, enable wide tuning of dielectric properties via control of temperature, electric fields, optical fields or disorder. The distinct dielectric states can be volatile or non-volatile depending on how the phase is created. In different implementations, the correlated oxides such as NbO₂, V₂O₃ and VO₂ are used to fabricate composites utilizing sequential and/or co-deposition fabrication techniques as well as local controlled disorder in order to form islands of the oxides in a dielectric and insulating matrix.

By combining the distinct insulating and metallic states in these composites and by control of the ground state via induced defects, artificial electronic composites are created and their properties can be tuned.

In general, the composites are used in radio frequency (RF) to high frequency circuit elements that operate in the RF and GigaHertz (GHz) ranges, and higher. Examples include millimeter wavelengths and microwaves. The composites can be used to enable frequency tunability of coplanar waveguide devices. The composites are also used in other embodiments to create microwave switch elements. More generally, the correlated oxide composite devices are used in tunable antennas, tunable capacitors, tunable filters, matched networks, phase shifters, and a number of other tunable RF, GHz, millimeter wave, and/or microwave circuit applications. They are switched or linearly tuned. In addition, tuning modalities employed by switching modules can utilize temperature control of the composite, changing the electric field applied to the composite, or irradiation of the composite with electromagnetic (EM) radiation and ion beam. This irradiation can involve visible light, ultraviolet or infrared wavelengths.

In general, according to one aspect, the invention features an electrical element. This element comprises a dielectric material with islands of a phase change material in the insulating dielectric matrix. The element further comprises one or more electrodes adjacent to the dielectric material.

Typically, the islands include NbO₂, V₂O₃ and/or VO₂. In a current example, the dielectric material includes silica.

In embodiments, there are two electrodes adjacent to the dielectric material. As a result, the electrical element can be a capacitor or a device that utilizes the capacitive effect.

For best operation, the phase change material is below percolation level in the dielectric material.

In some implementations, there is a switching module that initiates a transition of the phase change material. This switching module might initiate the transition by irradiating the materials with ions or electromagnetic radiation such as light in the infrared, visible, ultraviolet, or shorter wavelengths.

In other cases, the switching module initiates a transition of the phase change material by controlling a local temperature of the islands and/or by controlling an electric field flux through the islands.

In examples, the electrical element includes a coplanar transmission line with ground conductors on either lateral side of the electrodes. In other examples, the electrical element includes ring resonator.

In general, according to another aspect, the invention features a method of fabricating an electrical element. This method comprises fabricating islands of a phase change material including NbO₂, V₂O₃ and/or VO₂ in a dielectric material. In addition, one or more electrodes are fabricated adjacent to the dielectric material.

In embodiments, fabricating the islands comprises creating three-dimensional islands of the phase change material in the dielectric material by sequential deposition and thickness control. Fabricating the islands can also comprises depositing sequential layers of the dielectric material followed by etching of the dielectric material and deposition of the phase change material to create patterned dispersions.

The above and other features of the invention including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention. Of the drawings:

FIGS. 1A and 1B are cross-sectional views of tunable elements utilizing the phase change composites according to the present invention showing two planar electrodes sandwiching the phase change composite.

FIG. 2 is a plot of transition magnitude (magnitude of resistance change across the transition—an indirect measure of the gap change) as a function of temperature in Kelvin for different materials, the mechanism of phase transition is included in parentheses for some material systems.

FIG. 3 is a plot of resistance in Ohms as a function of temperature in Celsius for VO₂ film.

FIGS. 4A and 4B are a top view and a side cross-sectional view of a coplanar waveguide with a VO₂ correlated oxide composite element in the signal conductor.

FIG. 5 shows a ring resonator circuit element with a VO₂ correlated oxide composite substrate.

### DETAILED DESCRIPTION OF THE PREFERRED EMBODIMENTS

The invention now will be described more fully hereinafter with reference to the accompanying drawings, in which illustrative embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

As used herein, the term “and/or” includes any and all combinations of one or more of the associated listed items. It will be further understood that the terms: includes, comprises, including and/or comprising, when used in this specification, specify the presence of stated features, elements, and/or components, but do not preclude the presence or addition of one or more other features, elements, components, and/or groups thereof. Further, it will be understood that when an element, including component or subsystem, is referred to and/or shown as being connected or coupled to another element, it can be directly connected or coupled to the other element or intervening elements may be present.

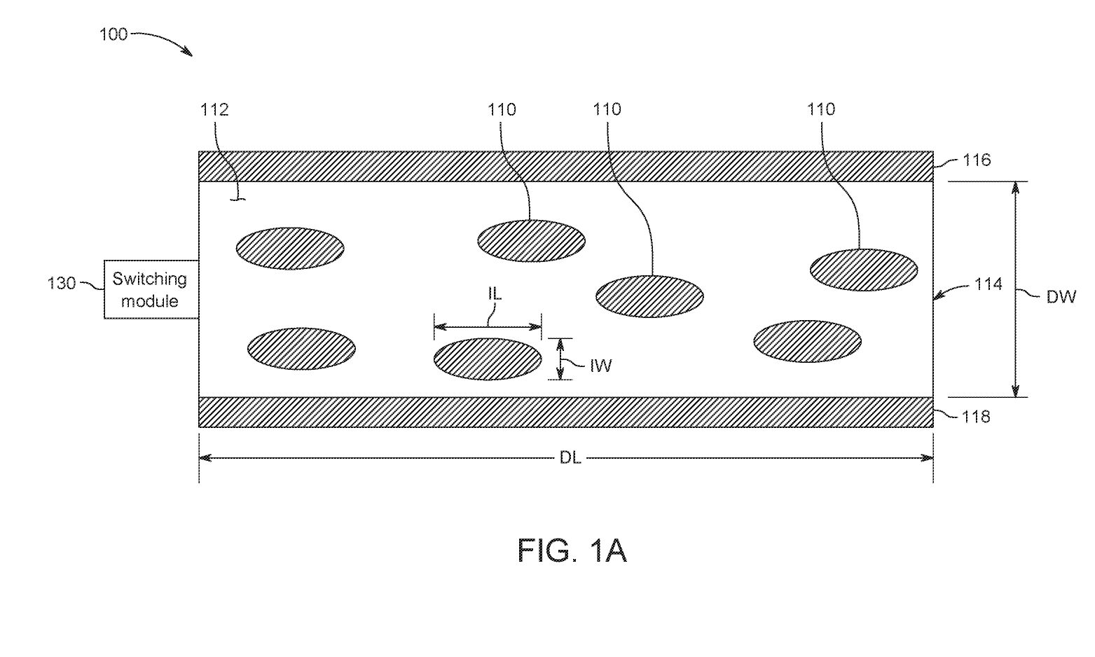

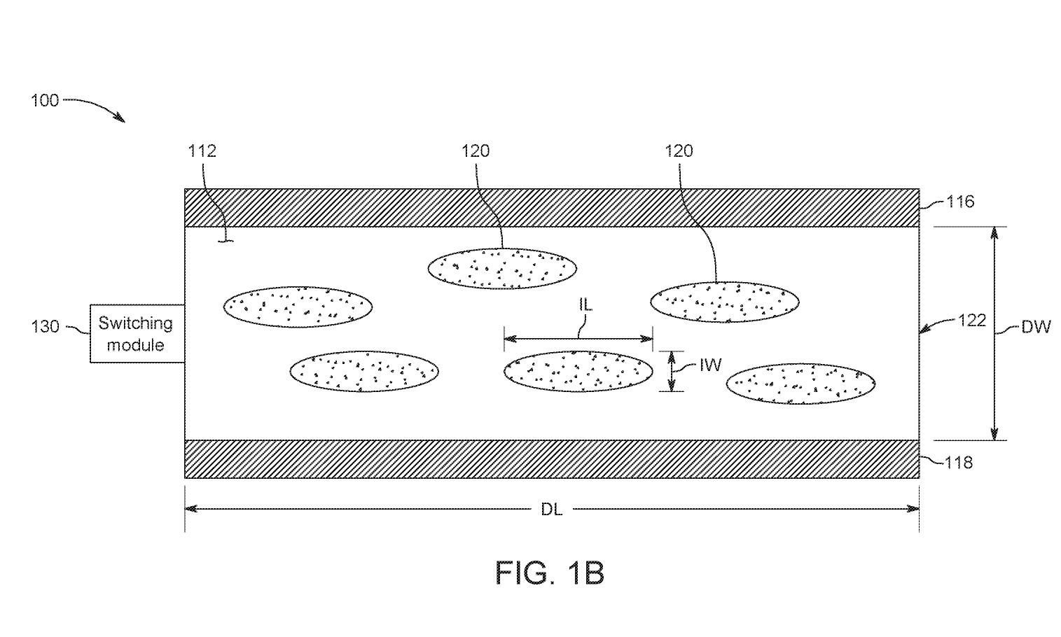

FIGS. 1A and 1B show tunable electrical elements 100 including tunable capacitor structures which have been constructed according to the principles of the present invention.

FIG. 1A shows a first embodiment of an electrical element 100 such as a capacitor. Here, a non-volatile disorder induced metallic phase change material islands 110 are incorporated into the insulating dielectric matrix 112 to form the correlated oxide composite 114. The composite 114 is sandwiched between two planar electrodes 116, 118.

The insulating matrix 112 can be one of two types: a wide bandgap insulator such as silica or a narrow gap insulator in a deep insulating state such as NbO₂.

The dimensions (IL and IW) of the islands 110 are preferably much smaller than the dimensions (DL and DW) of the electrical element 100. That is, the typical island width IW is at least as small as one-tenth ( 1/10) of distance DW between the electrodes 116, 118, (IW<<DW/10). Similarly, the typical island length IL is at least as small as one-tenth of the device length DL, length of the electrodes 116, 118, (IL<<DL/10).

The metallic phase change material islands 110 introduced via disorder will have distinct properties compared to the thermally induced metallic phase.

According to the invention, a switching module 130 is further provided. The module 130 controls the local temperature of or electric field flux through or electromagnetic radiation EM irradiation exposure of the correlated oxide composite 114. In this way, the composite 114 is switched between entirely insulating to containing metal-like dispersed phases (i.e., conducting). This is used to tune the electrical element by changing the permittivity or dielectric constant of the composite 114.

FIG. 1B shows a second embodiment of an electrical element 100 such as a capacitor. Here, bias-tunable pristine phase change material islands 120 are incorporated into an insulating matrix 112 (similar to FIG. 1A) to form the correlated oxide composite 122 by co-deposition. The composite 122 is sandwiched between two planar electrodes 116, 118.

Here, the switching module 130 also controls the local temperature of or electric field flux through (using electromagnetic current) the correlated oxide composite 122. In this way, the composite is switched between entirely insulating to containing metal-like dispersed phases. This is used to tune the electrical element by changing permittivity or dielectric constant of the composite 114.

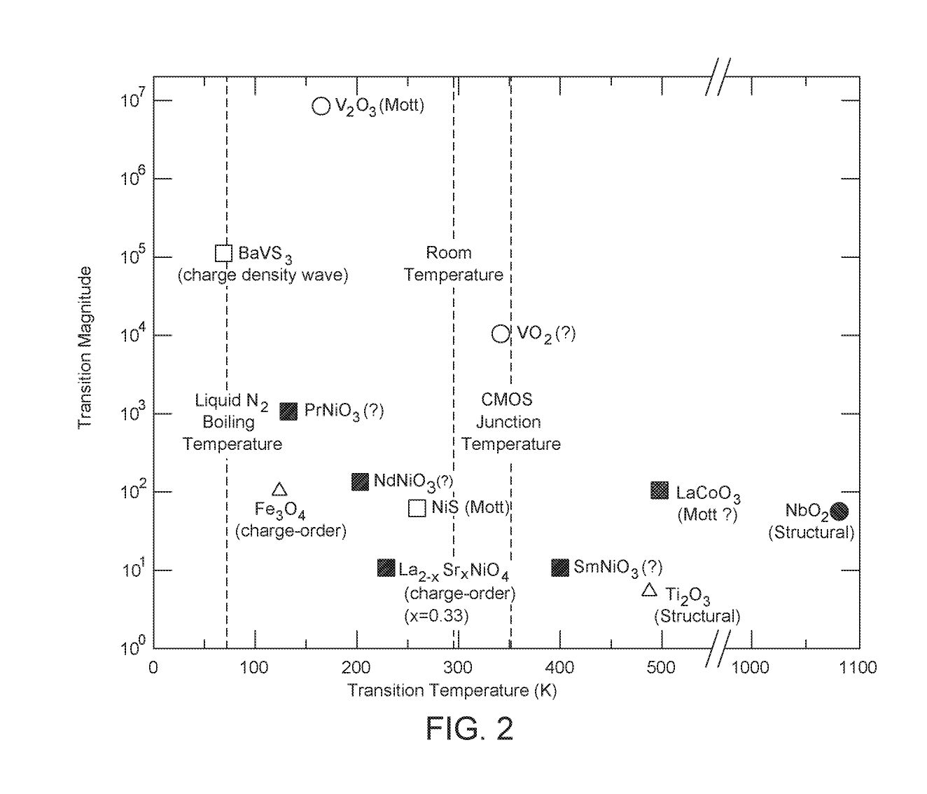

FIG. 2 is a survey of different materials that undergo thermal insulator-metal transitions. The dielectric properties vary dramatically across the transition due to the large change in free carrier density. The x-axis shows the transition temperature (in Kelvin, K) where the materials, mostly metal oxides, with exception of BaVS₃ and NiS, undergo thermal phase change from being insular to metal like conductors. The y-axis shows the magnitude of increase in conductance.

Phase change materials like NbO₂, V₂O₃, and VO₂ show thermal phase transitions. These are volatile in the sense that when the stimulus is removed they will go back to the original state. For instance, at room temperature, NbO₂ is insulating, stoichiometric VO₂ is insulating while V₂O₃ is metallic (thus conducting).

If a phase change material is incorporated as islands 110, 120 into a dielectric matrix 112 (e.g., silica) then depending on the local temperature, the composite 114, 122 will be entirely insulating or containing metal-like phases dispersed. This offers a thermal or voltage tunability opportunity. This also offers effective medium models for dielectric permittivity and Maxwell-Wagner type polarization phenomena.

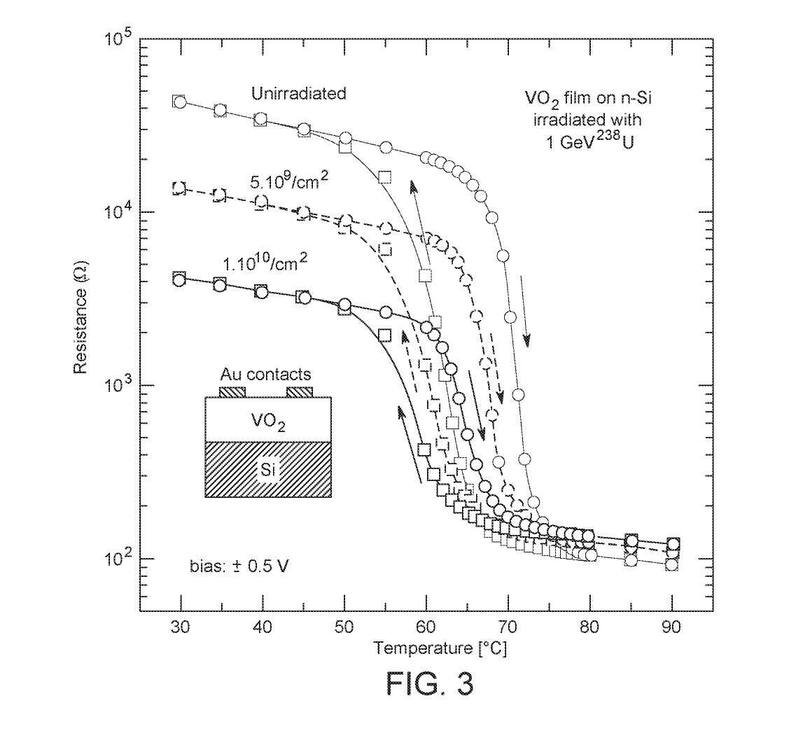

FIG. 3 shows a method for suppressing the insulation state (i.e., increase conductivity or lower resistance) in a non-volatile manner. The suppression is non-volatile in the sense that insulation property will not increase even after lowering the temperature of system shown in FIG. 2. See Hofsäss, Ehrhardt, Gehrke, Brötzmann, Vetter, Zhang, Krauser, Trautmann, Ko, and Ramanathan, “Tuning the conductivity of vanadium dioxide films on silicon by swift heavy ion irradiation”, AIP Advances, 1(3), p. 032168, 2011.

Here, on irradiation (U238 ion, 1 GeV energy) of VO₂ leads to suppression of the insulating state. This is another way to tune the dielectric properties of a phase change material. The suppression of the metallic state is non-volatile as it is induced by structural disorder. The transition for a VO₂ film on silicon for unirradiated and irradiated with ion is shown. The irradiation flux numbers are stated on left above the curves. As can be seen, higher irradiation leads to lower resistance (more suppression of insulation). The downward arrow shows the heating process and up-arrow indicates cooling process. All pairs of curves do show hysteresis.

In different embodiments, one more of these phase change materials, such as NbO₂, V₂O₃, VO₂, are incorporated as islands 110, 120 into a dielectric matrix 112 (e.g., silica) to create the correlated oxide composite 114, 122. These composites are located between two electrodes 116, 118 to form an electrical element or device such as a capacitor or an electrical element that has capacitive properties.

Then, by controlling the local temperature or electric field flux or EM irradiation via control of the switching module 130, the composite 114, 122 is switched between entirely insulating to containing metal-like dispersed phases. This provides thermal or voltage tunability of the electrical element.

In other embodiments, the composites 114, 122 retain the final conducting states independent of temperature or applied electric field bias, to yield non-volatile or hysteretic behavior. Specifically, non-volatility is induced by the switching module into the composite 114, 122 by controlling disorder to transition between conducting and insulating state.

One approach for controlling such disorder is using a switching module 130 that ion irradiates composite 114, 122 that is made from an oxide system like VO₂. The ion irradiation from the module 130 will cause the resistance of material islands 110, 120 to drastically change leading to islands in a metallic-like state with high conductivity.

Another method to create new metal-like phase is using a switching module 130 that induces disorder in the anion sub-lattice by annealing in extremely reducing environment. The dielectric properties of this phase are different from the nominal insulating state. Unlike the thermally-driven metal phase, disorder-induced metal-like phase is non-volatile and not temperature dependent. In short, the switch module permanently changes the composite 114, 122 from insulator to metal-like (i.e., conducting).

Materials and Composite Fabrication Methods.

To grow correlated oxide composites 114, 122, two approaches are preferred.

In one approach, the three-dimensional islands 110, 120 of the correlated oxide inclusions are grown in the insulating matrix 112 by sequential deposition and thickness control. Oxides like VO₂ and NbO₂ can grow in clustered 3D form on surfaces.

In another approach, sequential layers are grown followed by reactive ion etching of correlated oxide inclusion layers to create patterned dispersions or islands. Once a layer is patterned, further deposition insulating matrix followed by patterning will lead to another layer of inclusions. This approach leads to better control over the periodicity.

To create the disordered phases, two methods can be employed. One is to perform ion irradiation on the oxide layers 112 to create locally metallic regions and the second approach is to anneal the films in highly reducing environments. The rate of reduction of the correlated oxides is much faster than that of the insulating matrix such as silica and hence it is possible to create the composite structures at near-ambient temperatures. The electrodes 116, 118 used are preferably a noble metal like platinum (Pt) to serve as electrical contacts.

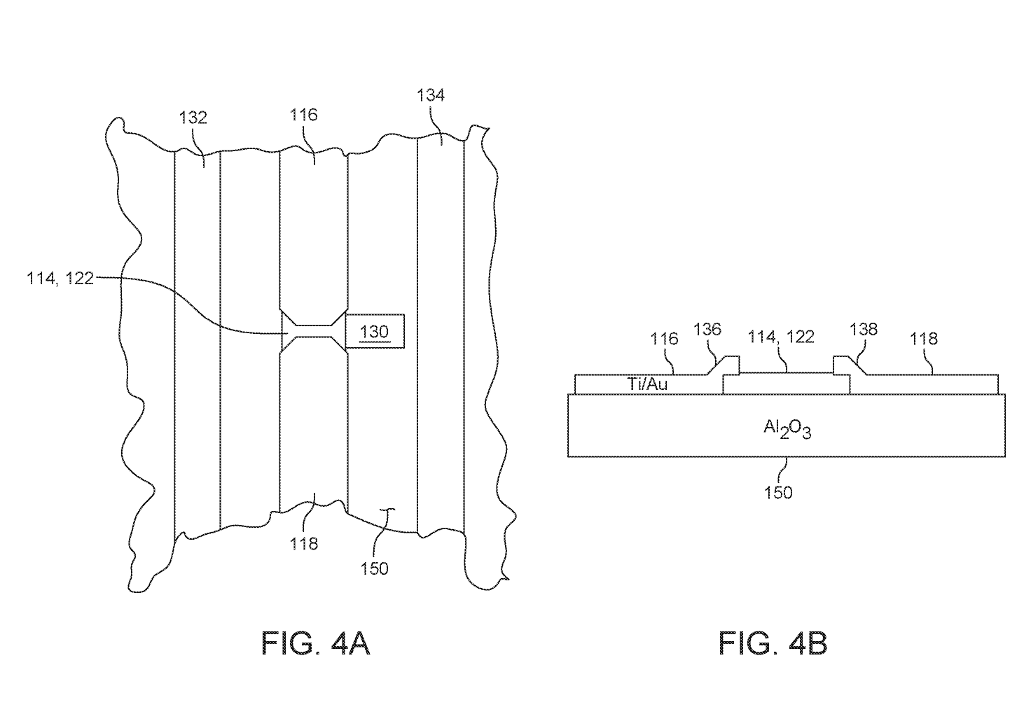

FIGS. 4A and 4B illustrate a coplanar transmission line with a high frequency circuit element fabricated from the tunable dielectric composite 114, 122. This structure could be used with the composite material to implement a tunable series capacitor. Combined with transmission line elements, it could be part of a variable filter or matching network.

In more detail, the correlated oxide composite 114, 122, preferably with VO₂ islands (composite with VO₂ inclusions) is provided between two sections or electrodes 116, 118 of a signal conductor fabricated from Ti/Au, for example. The signal conductors 116, 118 have been deposited and patterned on an Al₂O₃ substrate 150. Ground conductors 132, 134 are located on either lateral side of the signal conductors 116, 118, which are also Ti/Au amalgam that have been deposited and patterned on the Al₂O₃ substrate 150.

At the junction between the signal conductors 116, 118, the tunable dielectric composite 114, 122 is deposited or otherwise formed. Typically, the switching module 130 is adjoining or adjacent the composite 114, 122 to control the composite by changing it temperature or exposing the composite 114, 122 to an electric field flux or exposing the composite 114, 122 to EM irradiation. Thus, the switching module 130 will change the conductivity and/or the relative permittivity or dielectric constant of the composite 114, 122. The composite 114, 122 is switched between entirely insulating to containing metal-like dispersed phases. This provides thermal or voltage tunability of the electrical element.

As shown in the cross-section of FIG. 4B, each of the sections or electrodes 116, 118 include nose portions 136, 138 where they make electrical contact with the tunable dielectric composite 114, 122. These nose portions 136, 138 increase the surface area contact in order to increase the capacitance of the circuit element.

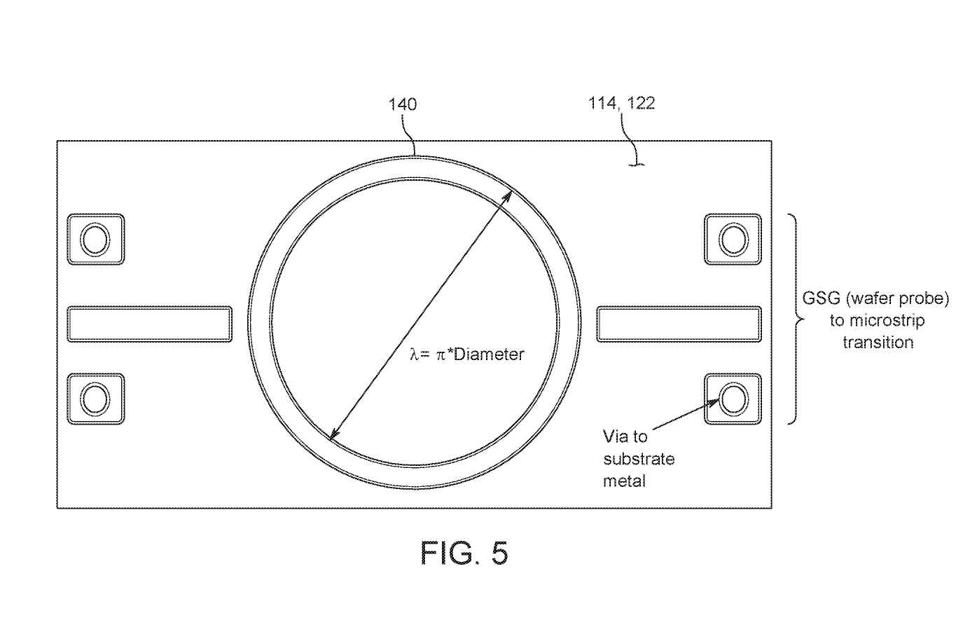

Another implementation is shown in FIG. 5. Here a tunable dielectric composite circuit device is fabricated in a ring resonator 140. In one example, the substrate 114, 122 on which the metal circuit device 140 is fabricated is the tunable dielectric composite. In general, resonances appear at frequencies where the circumference is a multiple of the electromagnetic wavelength. For a frequency range of 10-20 GHz, and for 1 micrometer composite films with a nominal relative permittivity of 10, the ring diameters d are in the range of 2-4 mm. The traces will need to be in the range of 10 micrometers. The metal can be lithographically patterned and etched.

The S-parameters of the ring resonator 140 will give real and imaginary components of the dielectric constant at the resonance frequency after de-embedding fitting.

While this invention has been particularly shown and described with references to preferred embodiments thereof, it will be understood by those skilled in the art that various changes in form and details may be made therein without departing from the scope of the invention.

What is claimed is:

1. An electrical element, comprising:
a dielectric matrix with islands of a phase change material; and
one or more electrodes adjacent to the dielectric material.

2. The element of claim 1, including NbO₂, V₂O₃ and/or VO₂

3. The element of claim 1, further comprising two electrodes adjacent to the dielectric material.

4. The element of claim 1, wherein the electrical element is a capacitor.

5. The element of claim 1, wherein the phase change material is below percolation level in the dielectric material.

6. The element of claim 1, where the dielectric matrix includes silica.

7. The element of claim 1, further comprising a switching module that initiates a transition of the phase change material.

8. The element of claim 1, further comprising a switching module that initiates a transition of the phase change material by irradiating the materials.

9. The element of claim 1, further comprising a switching module that initiates a transition of the phase change material by controlling a local temperature of the islands.

10. The element of claim 1, further comprising a switching module that initiates a transition of the phase change material by controlling an electric field flux through the islands.

11. The element of claim 1, wherein the electrical element includes a coplanar transmission line with ground conductors on either lateral side of the electrodes.

12. The element of claim 1, wherein the electrical element includes ring resonator.

13. A method of fabricating an electrical element, comprising:
fabricating islands of a phase change material in a dielectric material; and
fabricating one or more electrodes adjacent to the dielectric material.

14. The method of claim 13, wherein the islands include NbO₂, V₂O₃ and/or VO₂.

15. The method of claim 13, wherein fabricating the islands comprises creating three-dimensional islands of the phase change material in the dielectric material by sequential deposition and thickness control.

16. The method of claim 13, wherein fabricating the islands comprises depositing sequential layers of the dielectric material followed by etching of the dielectric material and deposition of the phase change material to create patterned dispersions.

17. The method of claim 16, wherein the etching is reactive ion etching.
